(19) United States
(12) Patent Application Publication
(10) Pub. No.: US 2025/0321643 A1
(43) Pub. Date: Oct. 16, 2025

(54) AUTOMATED ASSISTANT ADAPTED TO FACILITATE SIGN LANGUAGE INTERACTIONS AND DISCOVERABILITY OF RELATED FUNCTIONALITY

(71) Applicant: GOOGLE LLC, Mountain view, CA (US)

(72) Inventors: Thad Starner, Atlanta, GA (US); Perrin Anto, New York, NY (US); Sepehr Sam Sepah, Pleasanton, CA (US); Tuan Nguyen, San Jose, CA (US); Manfred Georg, St. Louis, MO (US); Garrett Tanzer, Boston, MA (US); Sana Mithani, Plantation, FL (US); Sai Aditya Chitturu, Sunnyvale, CA (US); William A. Truong, San Jose, CA (US)

(21) Appl. No.: 18/636,006

(22) Filed: Apr. 15, 2024

(51) Int. Cl. G06F 3/01; G06V 40/20

(52) U.S. Cl. CPC G06F 3/017; G06F 3/013; G06V 40/28

(57) ABSTRACT

Implementations described herein relate to an automated assistant that is responsive to sign language commands and can provide feedback to assist a user with efficiently controlling the automated assistant using sign language. When the user is initially detected, and/or the automated assistant otherwise determines that the user intends to invoke the automated assistant, the automated assistant can render graphical output and/or a depiction of one or both hands of the user (or a representation thereof). In some implementations, this depiction can be a static representation of hands, or a dynamic representation (e.g., an avatar) that mimics the movement of one or both hands of the user. When the user provides a sign language command, an American Sign Language (ASL) Gloss interpretation (or corresponding natural language interpretation thereof) can be rendered at the display interface, along with any autocomplete suggestions and/or suggestions for other commands.

### BACKGROUND

Humans may engage in human-to-computer dialogs with interactive software applications referred to herein as “automated assistants” (also referred to as “digital agents,” “chatbots,” “interactive personal assistants,” “intelligent personal assistants,” “assistant applications,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input.

The ability for a user to invoke an automated assistant can sometimes be dependent upon whether they have any conditions that affect their ability to communicate information and/or receive information. For example, certain users may have completely diminished or partially diminished hearing, and/or may rely upon sign language or other inaudible communications techniques in their daily lives. As a result, these users' opportunities to invoke an automated assistant at, for example, a standalone display device, may be limited to directly contacting a touch interface of the standalone display device. This can be in part because certain standalone assistant devices may exclusively rely on a microphone to detect an invocation phrase, rather than providing any other means for receiving an inaudible invocation command.

In some instances, even if a computing device does enable inaudible commands to control certain applications (e.g., hand waving over a proximity sensor, detecting presence of a user within a camera's field of view, etc.), the computing device or application may not be suitable for sign language interpretation. For example, facilitating sign language communications with an assistant-enabled device by exclusively relying on a dedicated video camera can prove unreliable because of limitations of field of view of the camera and limitations when providing feedback to the user. In one hypothetical instance, a hearing-impaired user may not be able to perceive whether a successful invocation was performed (e.g., “Hey, Assistant . . . ”) because the feedback indicating successful invocations may be provided exclusively via audio (e.g., a chime sound).

Alternatively, and in another hypothetical instance, a field of view of a camera can limit an ability for a user to provide non-verbal input because such inputs can incidentally occur outside a field of view of the camera. As a result, a user may provide a non-verbal input to their assistant device without any acknowledgement that their inputs are not being received by their automated assistant, despite otherwise standing close enough to the device to effectuate such communications. Furthermore, preserving the privacy of a user can be a concern when a camera is being relied upon for non-verbal communications, but the user otherwise prefers the camera to be off when they are not interacting with their automated assistant.

### SUMMARY

Implementations described herein relate to an automated assistant or other application that can receive sign language and/or other inaudible communications in a manner that is more realistic for signing users, at least relative to signing that occurs between persons (e.g., two people communicating with their hands). Some implementations described herein also enable inaudible communications for hearing-impaired users with an automated assistant without omitting portions of signing gestures that can occur outside of a field of view of a camera (or other vision sensor). Furthermore, some implementations described herein facilitate accurate invocation of automated assistants, and effective assistant feedback, for users that rely, at least in part, on inaudible forms of communications for assistant interactions.

In some implementations, the automated assistant can determine that a user is intending to invoke the automated assistant by determining whether the user has walked into a field of view of a camera (or other vision sensor) of an assistant-enabled device and turns to face the camera. For example, the camera and/or other sensor of the computing device can detect motion and, in response, initialize further detection of a face of the user and/or other feature(s) of the user to confirm that the user is intending to interact with the automated assistant. In response to determining the user is intending to invoke the automated assistant, the assistant-enabled device can exhibit a change in status (e.g., awaken the display, blink a light, etc.) to indicate to the user that the automated assistant is ready to receive a sign language command.

In some implementations, the automated assistant can determine that a user is intending to invoke the automated assistant by tracking a hand of the user and providing feedback to the user to indicate that a hand of the user is being detected. For example, a display interface of a computing device (e.g., a tablet, smart home device, etc.) can render a representation of one or both hands of the user when a hand is detected. The rendering of a hand can be an outline of the hand or other reduced, or enhanced, representation of the hand in real-time. In some implementations, video feed from the camera of the computing device can be rendered in addition to the rendering of the hand. Alternatively, the video feed from the camera can be omitted and otherwise not displayed at the display device simultaneous to the rendering of the hand. When the rendering of the hand is presented at the display interface in response to detecting the hand of a user, the user can be put on notice that the automated assistant is ready to receive a sign language command (e.g., a hand-signed command such as “What is the news today?”, to see a compilation of news videos with closed captioning).

In some implementations, a computing device can gradually indicate that an automated assistant is ready to receive a sign language command or other non-verbal command. For example, when a user walks into a field of view of a camera of the computing device and/or faces a display interface of the computing device, the computing device can exhibit a first feature for indicating a preparedness to receive a sign language command. Before or after this, when a hand of the user is detected (e.g., because the user intentionally motioned their hand or otherwise was detected without express intention by the user, but with prior express permission to perform such detection), the computing device can exhibit a second feature for indicating preparedness to receive a sign language command. In some implementations, the first feature can be a display interface awakening in response to the user being detected in the field of view of the camera and the second feature can be the rendering of a hand at the display interface. The hand that is rendered can be an animated outline, animated reduced rendering, and/or animated enhanced rendering, of a hand of the user to indicate that the hand of the user is being detected (rather than simply rendering a generic image of a hand). For example, when the user raises their hand to invoke their automated assistant after the display interface has awakened, the movement and position of the hand can be mimicked by the rendering of the hand being displayed at the display interface of the computing device.

In some implementations, the first feature and/or the second feature can include rendering an avatar at the display interface. When the user begins to provide a sign language command to the computing device and/or automated assistant, the avatar can then mimic or otherwise motion to convey that the automated assistant is receiving the sign language command from the user. Alternatively, or additionally, the first feature and/or the second feature can include rendering a graphic at the display interface for encouraging the user to gaze at the graphic in furtherance of confirming that the user is intending to invoke the automated assistant. When the user does gaze toward or at the graphic, and the camera detects this gaze, the display interface can then provide the rendering of the hand to indicate the readiness of the automated assistant to receive a sign language command. In some implementations, the graphic can be animated such that the user would follow the graphic with their gaze to indicate that they are intending to invoke the automated assistant and/or provide a sign language command to their computing device. In some implementations, multiple graphics can be utilized so that the user can select a particular graphic with their gaze in order to indicate their intention. For example, a first graphic (e.g., a green spot) can be rendered for the user to gaze at to invoke the automated assistant and a second graphic (e.g., a red spot) can be rendered for the user to gaze at to indicate they are not currently intending to invoke the automated assistant.

In some implementations, rather than relying on gaze to select a particular graphic, the user can select a particular graphic by using a hand gesture. When the graphic is animated, the user can follow the graphic with their hand or other body part to indicate their selection of a particular graphic. Alternatively, or additionally, when the computing device is exhibiting the first feature and/or the second feature, the user can sign an invocation command (e.g., “Ok, Assistant . . . ”) to indicate their intention to provide a subsequent sign language command or other non-verbal command. As the user provides the sign language command, in any implementation, the automated assistant can rely on one or more techniques for determining when the user has completed the sign language command.

In some implementations, the automated assistant can rely on motion detection to determine that the user is no longer signing, or otherwise providing an express non-verbal command, and provide feedback to the user in response. For example, processing of vision data, audio data, and/or other sensor data can indicate that the user is finished providing their sign language command and, in response, an assistant-enabled device can exhibit an attribute such as a change to a display output, or other suitable output. In some implementations, the attribute can include one or more features for indicating that the automated assistant has understood the sign language command to be completed and for indicating what the automated assistant understood the sign language command to be. For example, the attributes can include static and/or animated graphics that are intended to convey, back to the user, the sign language command that the user provided to the automated assistant. In some implementations, the graphics can include images of hands, text, avatars, and/or any other graphics that can convey a command back to a user. In some implementations, the attributes can include a timer and/or a timer graphic that indicates an amount of time, or countdown, until the sign language command is processed by the automated assistant. During this time, the automated assistant can await a confirmation from the user and/or a modification to the sign language command, thereby mitigating any false interpretations being processed by the automated assistant. In some implementations, a confirmation that the interpretation of the sign language command is correct or incorrect can be provided as a touch input to the computing device that is detecting the sign language command and/or another computing device that is associated with the automated assistant.

In some implementations, the user can provide a sign language gesture or other non-verbal gesture to indicate an end to their sign language command. For example, a gesture that can indicate an end to a sign language command is the user removing their hand or hands from a field of view of the camera and/or otherwise causing a hand rendering to be removed from a display interface. Alternatively, or additionally, the user can sign a word or phrase that can indicate an end to the sign language command, such as “Finished”, “Please”, “Stop”, etc. Alternatively, or additionally, the user can perform a non-verbal gesture or other input, such as gazing at a portion of the display interface, a graphic, and/or a button in furtherance of indicating that they have finished signing the sign language command. In some implementations, one or more facial gestures can be provided to indicate an end to a sign language communication, such as squinting, moving eyebrows, blinking, moving lips, and/or any other bodily gesture that can be utilized to indicate an end to a command.

A sign language command can be initially processed locally at an assistant-enabled device before command data is communicated to another computing device (e.g., a cloud or server computing device) for further processing. For example, when the automated assistant provides an indication of the signs that were received from the user, the user can view the signs to confirm that the automated assistant interpreted the sign language command correctly. When a threshold duration of time expires, and/or the user otherwise provides an express indication that the sign language command is completed, the automated assistant can provide an indication (e.g., graphics, text, etc.) that the corresponding command data is going to be sent to the other computing device for further processing. In this way, the user can be made aware of any external processing that will be occurring with respect to their sign language inputs, thereby giving the user additional control over privacy of the user and security of their data. For example, should the rendered signs be incorrect and/or otherwise not represent the sign language command provided by the user, the user can provide an additional sign language command, or other input, to indicate that they would not like the command data to be further processed at another computing device and/or locally (e.g., by one or more local trained machine learning models).

In some implementations, indications that the automated assistant is actively utilizing the camera for detecting can include illuminating and/or blinking one or more lights associated with a camera, providing a haptic output that can be detected by a user who is providing non-verbal inputs, and/or providing visual inputs at a display interface of a computing device. Alternatively, or additionally, these indications can also be utilized to indicate to the user that the command data is being processed at another computing device and/or being processed locally. In this way, the user can elect to permit or stop any processing of their commands and/or inputs, thereby preserving the privacy of the user, the security of the user's data, and also reducing waste of resources that might be consumed processing commands that the user does not want processed.

In some implementations, the automated assistant can provide discoverability of features that can assist a user that may rely on non-verbal commands and/or sign language commands to communicate. Discoverability of features can be provided through feedback that can be exhibited through prompt responses during an ongoing sign language command to an automated assistant and/or through other feedback that is rendered after a user-assistant interaction is completed or has otherwise ended. For example, while a user is directing a sign language command to a camera (or other vision sensor) of an assistant-enabled device: a display interface can be illuminated, the display interface can render an outline or skeleton of the hands of the user (e.g., as a gloss image or as video), and/or the display interface can render an avatar that mimics the sign language command of the user. Other implementations for providing discoverability of features can include rendering output that is responsive to a user stopping their sign language command when they have completed the command or have otherwise decided to stop providing the sign language command.

In some implementations, providing graphics and/or text that indicate the automated assistant's interpretation of a sign language command or other non-verbal command can allow the user to learn the commands that the automated assistant understands. In some implementations, the graphics and/or text that is rendered in response to a sign language command can be an interpretation of the sign language command and/or suggestions for other inputs that the automated assistant can understand. For example, during a sign language command, the automated assistant can render English text glosses or corresponding natural language text (e.g., using a generative model that is trained to generate the corresponding natural language text based on the English text gloss) that indicates the interpretation of a sign language command. Simultaneously, the automated assistant can also render other text that suggests how the user can expressly indicate, to the automated assistant, when their sign language command is complete (e.g., text, or graphics of hands performing sign language, that communicates the following message: “When you're finished, just sign ‘Stop’”).

In some implementations, the automated assistant can render feedback with suggestions that can streamline the sign language command and reduce the amount of effort the user may exert to communicate their command. For example, the automated assistant can utilize input data and contextual data to determine an intent of the user and, based on this intent, provide selectable suggestions for parameters and/or slot values for an action to be performed. In some instances, when the automated assistant determines that the user is providing an invocation command (e.g., signing “Hey Assistant . . . ”), the automated assistant can render selectable suggestions of types of commands that users sometimes provide after invoking their automated assistant.

For example, the automated assistant can cause a display interface to render selectable chips or icons that have text or graphics that indicate actions such as “Send a Message”, “Turn On or Off”, “Get Directions to”, “Show my Calendar,” and/or any other action that can be performed by the automated assistant or associated application. In some implementations, these icons can be shown with animated thumbnails of a sign language command that can be utilized to select the icon and/or otherwise cause the action to be initiated when the icon is not present. In some implementations, when an icon is selected, the automated assistant can render a “sub” menu of icons corresponding to other parameters that can be identified for the selected action. For example, when a “Send a Message” icon is selected, the automated assistant can provide a submenu of icons to be rendered that identify different messaging applications (e.g., “Chat Application,” “Video Calling Application,” “Email Application,” etc.). As the user continues to navigate these menus and submenus of icons, the user can select enough parameters for an action to be performed. When the user is ready for the action to be executed, the user can provide a sign language command that would otherwise indicate that their sign language command is completed (e.g., “Done”, “Stop”, etc.).

The above description is provided as an overview of some implementations of the present disclosure. Further description of those implementations, and other implementations, are described in more detail below.

### BRIEF DESCRIPTION OF THE DRAWINGS

FIG. 1A, FIG. 1B, FIG. 1C, FIG. 1D, FIG. 1E, FIG. 1F, and FIG. 1G illustrate views of a user interacting with an automated assistant that is responsive to sign language and/or other non-verbal commands.

FIG. 2 illustrates a system that facilitates an automated assistant or other application that can receive sign language and/or other inaudible communications in a manner that is more realistic, intuitive, and discoverable for signing users.

FIGS. 3A and 3B illustrate a method for operating an automated assistant that facilitates interactions through sign language commands and/or inaudible gestures and provides discoverability of features for making such interactions more efficient.

FIG. 4 is a block diagram of an example computer system.

### DETAILED DESCRIPTION

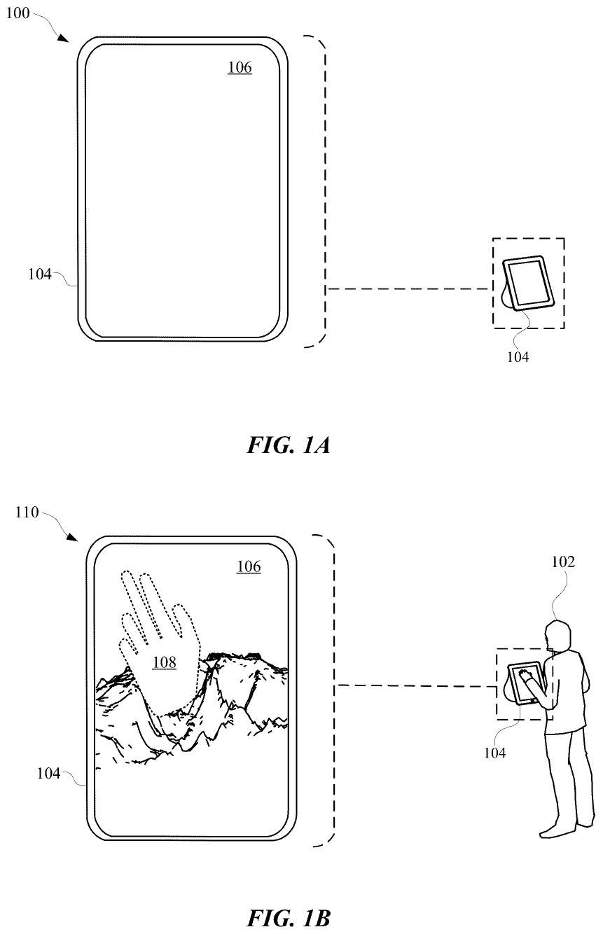

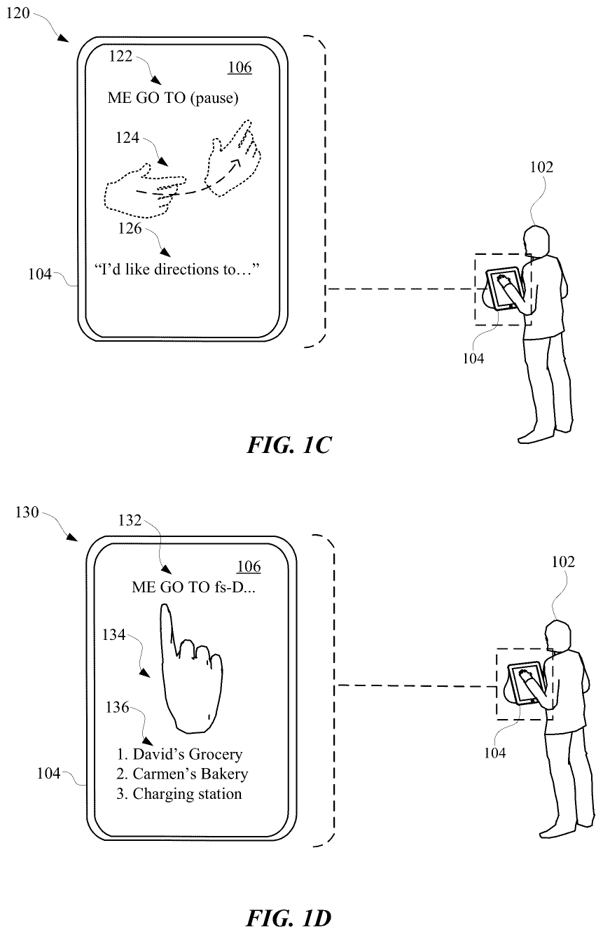

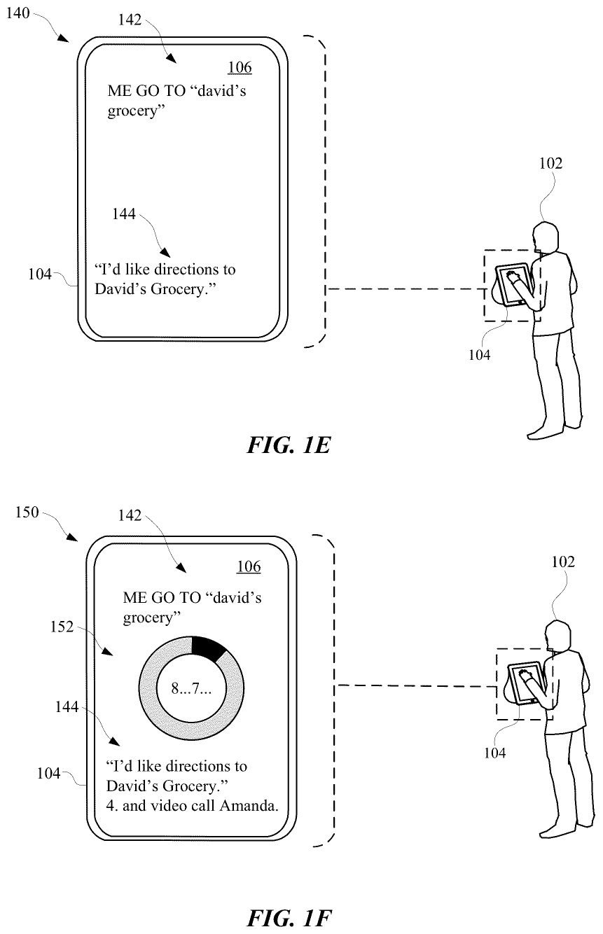

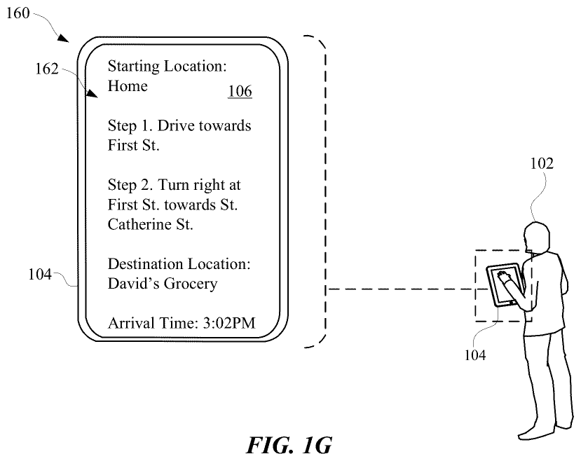

FIG. 1A, FIG. 1B, FIG. 1C, FIG. 1D, FIG. 1E, FIG. 1F, and FIG. 1G illustrate views 100, 110, 120, 130, 140, 150, and 160, respectively, of a user 102 interacting with an automated assistant that is responsive to sign language commands and/or other non-verbal commands. The automated assistant can be accessible via a computing device 104, which can be a standalone display device or other type of computing device that can provide access to an automated assistant. Initially, and as illustrated in view 100 of FIG. 1A, the computing device 104 can be in a standby, low power mode (e.g., lower power consumption, reduced sampling rate for one or more sensors, etc.), and/or otherwise be idle when a user is not present at or near the computing device 104. For example, and with prior permission from the user 102, the automated assistant and/or other application can determine a presence of the user 102 using sensor data generated at one or more sensors associated with the computing device 104. The sensor data can include vision data, proximity data, temperature data, audio data, and/or any other type of data that can be generated using one or more sensors of the computing device 104 (or another computing device in communication with the computing device 104). In some implementations, the sensor data can include vision data, and the vision data can be processed to determine a gaze of the user 102 and, in response to determining that the user 102 is directing their gaze at the computing device 104, the automated assistant can initialize one or more operations. For example, the one or more operations can include determining whether the user 102 is intending to interact with the automated assistant via sign language commands and/or other non-verbal commands. In some implementations, the automated assistant can be responsive to detecting a presence of the user 102 and/or detecting one or more hands or other appendages of the user 102. As a result, the one or more operations can be initialized for preparing the automated assistant to be responsive to a sign language command from the user 102.

In some implementations, when a presence of the user 102 is detected and/or the user 102 is estimated to be interested in interacting with the automated assistant, the automated assistant can provide an indication that the automated assistant is prepared to receive a sign language command. Alternatively, or additionally, the automated assistant can detect a presence of one or more hands of the user 102, with prior permission from the user 102, and cause a display interface 106 of the computing device 104 to render a real-time depiction 108 (e.g., an animation, avatar, moving outline, etc.) of one or more hands of the user 102. Alternatively, or additionally, the automated assistant can detect a presence of one or more hands of the user 102, with prior permission from the user 102, and cause the display interface 106 of the computing device 104 to render a generic depiction of one or more hands (e.g., a real-time depiction of an arrangement of the user's hands). In some implementations, and as illustrated in view 110 of FIG. 1B, the depiction 108 can be a reduced, or enhanced, rendered depiction of one or more hands of the user 102, and can be updated dynamically as the user 102 moves their hands. In this way, the automated assistant can indicate to the user 102 that the automated assistant is already responding to hand movements of the user 102, and therefore is prepared to respond to a forthcoming sign language command.

In some implementations, the depiction 108 is rendered to indicate that any person can interact with the automated assistant using sign language commands and/or other non-verbal commands. In some implementations, the depiction 108 is rendered in response to one or more hands of the user 102 being detected within a field of view of the camera of the computing device 104 and/or otherwise within a threshold distance from the camera or computing device 104 for accurately detecting sign language commands from the user 102. The user 102 can begin providing an automated assistant request with, or without, providing a non-verbal invocation command (e.g., “Assistant . . . ”). For example, and as illustrated in view 120 of FIG. 1C, the user 102 can provide the beginning of a sign language command, such as a command requesting directions. In response to the user 102 providing the sign language command, the automated assistant can determine an American Sign Language (ASL) Gloss representation for the sign language command and/or a non-Gloss, natural language textual representation corresponding to the ASL Gloss representation for the sign language command.

For example, and as illustrated in view 120 of FIG. 1C, the automated assistant can cause the display interface 106 to render the ASL Gloss 122 “ME GO TO (pause)” in response to the user 102 providing the sign language command. Alternatively, or additionally, the automated assistant can cause the display interface 106 to render one or more hand symbols 124 that represent a particular sign language command the user 102 is currently providing, has already provided, and/or is expected to provide. Alternatively, or additionally, the automated assistant can cause the display interface 106 to render a non-Gloss, natural language textual representation 126 of the sign language command the user 102 is currently providing, has already provided, and/or is expected to provide. In this way, the user 102 can receive feedback regarding whether the automated assistant is accurately interpreting the sign language command being provided by the user 102. This can preserve computational resources that might otherwise be consumed when an automated assistant is interpreting a user input incorrectly, initializes an incorrect action, and/or otherwise causes a user to repeat their input for re-processing.

In some implementations, the automated assistant can provide one or more selectable suggestions 136 in response to the user 102 providing the sign language command. The one or more selectable suggestions can include suggestions for completing the sign language command, for other actions that the automated assistant can perform, and/or for any other services that the user 102 can engage the automated assistant to perform. For example, the selectable suggestions 136 can be generated by the automated assistant based on processing of the sign language command and any other data that the user 102 (or other users) has permitted the automated assistant to access. As a result, the automated assistant can generate suggestions regarding actions that have been historically helpful to the automated assistant and/or actions that the user 102 has yet to cause the automated assistant to perform. In this way, a user that relies on sign language can receive suggestions regarding other assistant actions that the user can invoke via sign language commands.

In some implementations, when an ASL Gloss 132 is rendered at the display interface 106, the selectable suggestions 136 can also be rendered for indicating suggestions for completing the sign language command input to the automated assistant. For example, the selectable suggestions 136 can include autocomplete suggestions. Each suggestion can be rendered with a shortcut identifier that can put the user on notice of a sign language command, non-verbal gesture, or other input that can be provided to the automated assistant to select the suggestion. For instance, and as illustrated in view 130 of FIG. 1D, a particular suggestion such as “David's Grocery” can be selected by providing the sign language command for the number “1” because this particular suggestion is rendered adjacent to “1.”. When the user 102 provides the sign language command for “1”, a depiction 134 of a hand of the user 102 can be rendered at the display interface 106, thereby giving the user 102 confirmation that the automated assistant has understood the selectable suggestion that the user 102 identified.

In some implementations, selecting a selectable suggestion 136 can cause a sub-menu of one or more additional selectable suggestions to be rendered (e.g., “4 . . . in 30 minutes.”), thereby allowing the user 102 to further their interaction without having to fully sign these sign language commands. Instead, the user 102 can provide another shortcut sign command for indicating a selection of a sub-menu suggestion (e.g., providing a sign language command for the number “4”). Alternatively, the sub-menu can indicate other actions that the automated assistant can perform and that are associated with the parent suggestion that the user 102 has just selected. For example, when the user 102 selects the “1” selectable suggestion, a sub-menu can be rendered with another suggestion for calling a cab (e.g., “4. Use Cab App to take me to David's Grocery.”). In this way, instead of signing the entire command for effectuating the sub-menu action, the user 102 can simply sign the shortcut associated with the sub-menu suggestion (e.g., providing the sign language command for the number “4”). Although FIG. 1D is described with respect to using numbers to select a particular suggestion, it should be understood that is for the sake of example and is not meant to be limiting. For instance, other alphanumeric characters and/or sign language commands can be utilized to enable the user 102 to elect the particular suggestion.

In some implementations, the automated assistant and/or other application can detect a gaze of the user 102, with prior permission from the user 102, for determining whether the user 102 is gazing at any of the selectable suggestions. When the user 102 is determined to have gazed at a particular selectable suggestion for a threshold period of time, the automated assistant can execute an action corresponding to the gazed-at selectable suggestion. Alternatively, or additionally, the automated assistant can cause another graphic to be rendered at the display interface 106 as another option for selecting to not select any of the selectable suggestions. For example, this other graphic can be a red or green icon that, when gazed at by the user 102, causes the automated assistant to bypass executing any action associated with any of the selectable suggestions. In some implementations, a green or red icon can be rendered that, when gazed at by the user 102, causes the ASL Gloss representation of the command and/or non-Gloss, natural language textual representation of the command to be executed by the automated assistant (e.g., before a graphical timer expires, when the user 102 has completed providing the sign language command, and/or when the user 102 has not completed the sign language command but is otherwise satisfied with the rendered interpretation of the sign language command thus far).

In response to the user 102 selecting the first selectable suggestion, and as illustrated in view 140 of FIG. 1E, an updated ASL Gloss 142 can be rendered at the display interface 106 and/or an updated non-Gloss, natural language textual representation 144 can be rendered at the display interface 106. An ASL Gloss can be a representation of a sign language command that represents the individual signs in a first format (e.g., all capital letters), other features of the user during signing in a second format (e.g., “raised eyebrows”, expression of “apprehension”, expression of “joy”, etc. indicated with underlining), and/or a relationship between the individual signs in a third format (e.g., “long pause”, “short pause”, etc. indicated between special characters such as “*” or “/”). The textual representation that is rendered can describe the text of a command that, if provided via a spoken utterance, would effectuate the same one or more actions that the user 102 is invoking via the sign language command being provided (e.g., ME GO TO fs-D-A-V-I-D-S______pause______fs-G-R-O-C-E-R-Y).

In some implementations, and as illustrated in view 150 of FIG. 1F, the automated assistant and/or other application can cause a timer 152 or other graphical indication to be rendered at the display interface 106 to provide the user 102 with an indication of when the automated assistant will execute the user input. For example, the timer 152 can be a countdown timer from 10 seconds (or some other duration of time that is optionally configurable by the user 102) that causes the automated assistant to execute one or more actions associated with the sign language command when the countdown timer expires (e.g., reaches 0 seconds). In some implementations, one or more updated selectable suggestions can be rendered at the display interface 106 simultaneous to rendering the timer 152 as a way for the user 102 to quickly modify the action to be executed, and/or modify an interpretation of their sign language input.

For example, the automated assistant can cause another selectable suggestion such as “4, and video call Amanda”, which can refer to a suggested action the user 102 has previously requested when also requesting directions to a nearby grocery (e.g., “David's Grocery”). When the user 102 selects the selectable suggestion (e.g., by providing the sign language command for “4”), the automated assistant can queue this suggested action with the other pending action (e.g., getting directions to “David's Grocery”) and restart the timer 152. Upon expiry of the timer 152, the automated assistant can execute the pending action and the suggested action, without requiring the user 102 to sign all the corresponding words and phrases that would otherwise be required to communicate a request for such actions. For example, and as illustrated in view 160 of FIG. 1G, the automated assistant can cause the display interface 106 to render the directions 162 to “David's Grocery”, and an arrival time, in response to the user 102 providing the sign language command and selecting the shortcut. Alternatively, the user 102 can provide a confirming input, prior to the expiration of the timer 152, to cause the automated assistant to execute the actions without waiting for the timer 152 to expire. The confirming input can be, but is not limited to, a non-verbal gesture, gaze toward a particular icon or object, touch input, audible input, and/or any other input that can be received by the automated assistant.

By providing these streamlined means for controlling an automated assistant with sign language commands, certain forms of processing can be reduced, thereby preserving computational resources of any associated devices. For example, images and/or video of a complete sign language command would otherwise need to be cached in memory at the computing device 104 and/or server device when such shortcuts are not available. Therefore, on-device memory and cloud storage can be preserved by not requiring full sign language commands to be processed. Additionally, network bandwidth can be preserved in instances where a local device may rely on a remote device (e.g., server device) to process images and/or video for performing image recognition with any trained machine learning models (e.g., models trained to assist with recognizing ASL, generate ASL Gloss, generate non-Gloss, natural language textual representations corresponding to ASL Gloss, and/or convert images of signing to text). In some implementations, local models can be employed to recognize shortcut sign commands (e.g., “Assistant”, “1”, “2”, etc.), thereby eliminating the need to offload image processing to a server device before acting on a shortcut command. This can reduce response times of the automated assistant to ASL and other forms of non-verbal communications.

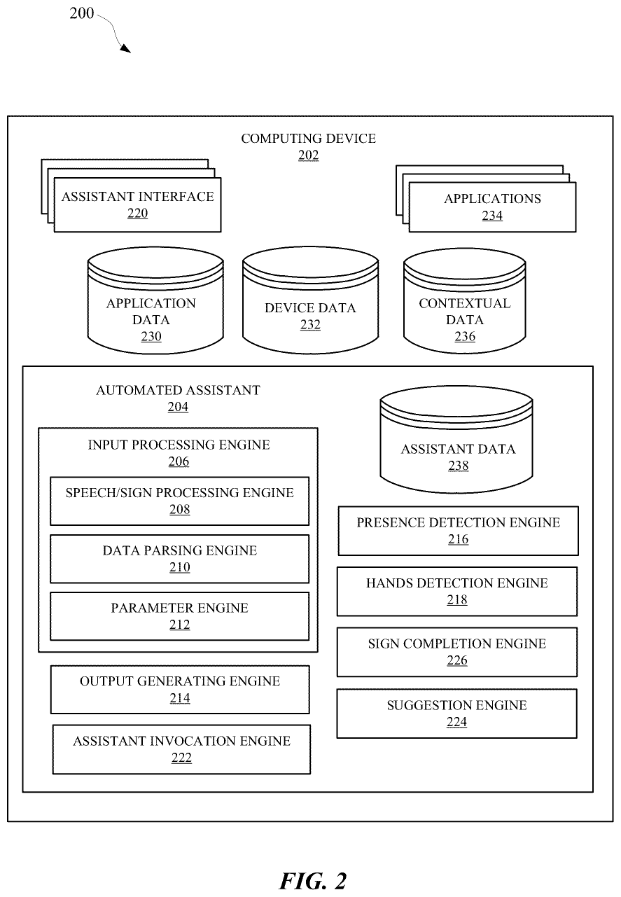

FIG. 2 illustrates a system 200 that facilitates an automated assistant or other application that can receive sign language and/or other inaudible communications in a manner that is more realistic, intuitive, and discoverable for signing users. For example, the automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal command, a non-verbal command (e.g., a gesture), a sign language command, a textual input, a touch input, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204.

The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user and/or non-spoken but audible inputs from the user (e.g., haptic, touch, etc.). In some implementations, the computing device 202 can include a touch interface and can be void of a camera (or other vision sensor) but can optionally include one or more other sensors.

The computing device 202 and/or other third-party client devices can be in communication with a server device over a network, such as the internet. Additionally, the computing device 202 and any other computing devices can be in communication with each other over a local area network (LAN), such as a Wi-Fi® network. The computing device 202 can offload computational tasks to the server device in order to conserve computational resources at the computing device 202. For instance, the server device can host the automated assistant 204, and/or computing device 202 can transmit inputs received at one or more assistant interfaces 220 to the server device. However, in some implementations, the automated assistant 204 can be hosted at the computing device 202, and various processes that can be associated with automated assistant operations can be performed at the computing device 202.

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system)—or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech/sign processing engine 208, which can process audio data and/or vision data received at an assistant interface 220 to identify any text to be interpreted from an input (e.g., a sign language command input). The input data can be transmitted from, for example, the computing device 202 to the server device in order to preserve computational resources at the computing device 202. Additionally, or alternatively, the input data can be exclusively processed at the computing device 202.

The process for converting the audio or vision data to text can include a speech or image recognition algorithm, which can employ neural networks, and/or statistical models for identifying groups or portions of input data corresponding to words or phrases. The text converted from the audio data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202 and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user (e.g., ASL Gloss, non-ASL Gloss text corresponding to ASL gloss, graphical feedback, selectable suggestions, etc.), and/or communicate with one or more applications 234 for providing an output to one or more applications 234.

Notably, in generating the ASL Gloss (e.g., the ASL gloss 122 in FIG. 1C), the output generating engine 214 can utilize, for instance, an ASL sign recognition model. The ASL sign recognition model can be trained to process image data and/or video data to detect sign language commands that are captured by the image data and/or the video data. Further, in generating the non-ASL Gloss text corresponding to ASL gloss (e.g., the non-Gloss, natural language textual representation 126 in FIG. 1C), the output generating engine 214 can utilize, for instance, a generative model. The generative model can be can be, for example, any LLM that is stored in the LLM(s) database 142A, such as PaLM, BARD, Gemini, BERT, LaMDA, Meena, GPT, and/or any other generative model, such as any other generative that is encoder-only based, decoder-only based, sequence-to-sequence based and that optionally includes an attention mechanism or other memory, and that is either unimodal or multimodal. Further, the generative model can be, for example, fine-tuned to process the ASL Gloss to generate the non-ASL Gloss text corresponding to ASL gloss.

For example, and in fine-tuning the generative model, a plurality of training instances can be obtained. Each of the plurality of training instances can include training instance input and training instance output, where the training instance input includes a corresponding training ASL gloss interpretation, and where the training instance output includes a corresponding natural language interpretation of the corresponding ASL gloss interpretation. Accordingly, and in fine-tuning the generative model, the ASL corresponding training ASL gloss interpretation can be processed using the generate model to generate output, such as a probability distribution over a sequence of tokens (e.g., word units, words, etc.) corresponding to natural language. Based on the probability distribution, a predicted natural language interpretation of the corresponding training ASL gloss interpretation can be determined. The predicted natural language interpretation can then be compared to the corresponding natural language interpretation of the corresponding ASL gloss interpretation to generate a loss that is used to update the generative model. Additionally, or alternatively, other techniques (e.g., reinforcement learning from human feedback (RLHF)) can be utilized to fine-tune the generative model.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device speech recognition, on-device object recognition, on-device sign language recognition, on-device natural language understanding, on-device generative model(s), on-device ASL gloss recognition, and on-device fulfillment. For example, on-device image recognition can be performed using an on-device image recognition module that processes vision data (detected by the camera(s)) using an end-to-end image recognition machine learning model stored locally at the computing device 202. The on-device image recognition generates recognized text for a sign language command (if any) present in the vision data. Also, for example, on-device natural language understanding (NLU) can be performed using an on-device NLU module that processes recognized text, generated using the on-device speech recognition, image recognition, and/or optionally contextual data, to generate NLU data.

NLU data can include intent(s) that correspond to a sign language command and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the sign language command (and optionally the parameter(s) for the intent). This can include determining local and/or remote responses (e.g., answers) to the sign language command, interaction(s) with locally installed application(s) to perform based on the sign language command, command(s) to transmit to internet-of-things (IoT) device(s) (directly or via corresponding remote system(s)) based on the sign language command, and/or other resolution action(s) to perform based on the sign language command. The on-device fulfillment can then initiate local and/or remote performance/execution of the determined action(s) to resolve the sign language command.

In various implementations, remote image processing, remote NLU, remote ASL gloss generation, remote non-ASL gloss textual generation, and/or remote fulfillment can at least selectively be utilized. For example, recognized text can at least selectively be transmitted to remote automated assistant component(s) for remote NLU and/or remote fulfillment. For instance, the recognized text can optionally be transmitted for remote performance in parallel with on-device performance, or responsive to failure of on-device NLU and/or on-device fulfillment. However, on-device signing processing, on-device NLU, on-device fulfillment, on-device ASL gloss generation, on-device non-ASL gloss textual generation and/or on-device execution can be prioritized at least due to the latency reductions they provide when resolving a sign language command (due to no client-server roundtrip(s) being needed to resolve the sign language command). Further, on-device functionality can be the only functionality that is available in situations with no or limited network connectivity.

In some implementations, the computing device 202 can include one or more applications 234 which can be provided by a third-party entity that is different from an entity that provided the computing device 202 and/or the automated assistant 204. An application state engine of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., device data 232) can be accessed by the automated assistant 204 to generate contextual data 236, which can characterize a context in which a particular application 234 and/or device is executing, and/or a context in which a particular user is accessing the computing device 202, accessing an application 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static but can be accessed by the application state engine in order to determine a suitable action to initialize via the automated assistant 204.

The computing device 202 can further include an assistant invocation engine 222 that can use one or more trained machine learning models to process application data 230, device data 232, contextual data 236, and/or any other data that is accessible to the computing device 202. The assistant invocation engine 222 can process this data in order to determine whether or not to wait for a user to explicitly speak or sign an invocation phrase to invoke the automated assistant 204 or consider the data to be indicative of an intent by the user to invoke the automated assistant—in lieu of requiring the user to explicitly speak or sign the invocation phrase. For example, the one or more trained machine learning models can be trained using instances of training data that are based on scenarios in which the user is in an environment where multiple devices and/or applications are exhibiting various operating states. The instances of training data can be generated in order to capture training data that characterizes contexts in which the user invokes the automated assistant and other contexts in which the user does not invoke the automated assistant. When the one or more trained machine learning models are trained according to these instances of training data, the assistant invocation engine 222 can cause the automated assistant 204 to detect, or limit detecting, spoken or signed invocation phrases from a user based on features of a context and/or an environment. Additionally, or alternatively, the assistant invocation engine 222 can cause the automated assistant 204 to detect, or limit detecting for one or more assistant commands from a user based on features of a context and/or an environment. In some implementations, the assistant invocation engine 222 can be disabled or limited based on the computing device 202 detecting an assistant suppressing output from another computing device. In this way, when the computing device 202 is detecting an assistant suppressing output, the automated assistant 204 will not be invoked based on contextual data 236—which would otherwise cause the automated assistant 204 to be invoked if the assistant suppressing output was not being detected.

In some implementations, the system 200 can include a presence detection engine 216 for determining whether a user is present near a device that provides access to the automated assistant 204. The presence of the user can be detected, with prior permission from the user, using sensor data from one or more sensors associated with the automated assistant 204. For example, object recognition can be performed on vision data generated by one or more sensors to determine that a person is present at or near the computing device 202. In response, the presence detection engine 216 can communicate with a hands detection engine 218 to determine whether any hands of the user are within a field of view of a camera (or other vision sensor).

Alternatively, in response to detecting the presence of the user, the presence detection engine 216 can initialize detection of a gaze of the user. When a gaze of the user is determined to be directed towards a camera, a graphical icon, and/or other object or feature, the automated assistant 204 can invoke the hands detection engine 218 for anticipating a sign language command from the user.

In some implementations, the hands detection engine 218 can determine whether one or both hands of the user are within a field of view of a camera (or other vision sensor). If they are, the hands detection engine 218 can provide, or bypass providing, positive feedback to encourage the user to keep their hands in the field of view of the camera if they are intending to provide a sign language command to the automated assistant 204. However, when one or both hands of the user are not detected by the hands detection engine 218, the hands detection engine 218 can cause an assistant interface 220 to provide negative feedback that indicates the hands of the user are not within a field of view of a camera. This negative feedback can be, for example, a graphical display output, a light blinking, a haptic output at a peripheral device, and/or any other feedback that can indicate that one or both hands of the user are not being detected.

When the user ultimately provides a sign language command that is detected and processed by the input processing engine 206, a sign completion engine 226 can determine or predict when the user has completed the command. In some implementations, this determination can be based on features of the user (e.g., facial expression, a common indicating such completion, and/or other feature) and/or a feature of a context of the user (e.g., lower audible sound, lack of motion in the environment, etc.). In some implementations, the sign completion engine 226 can cause a graphical timer to be rendered at an assistant interface 220 in response to a user pausing or stopping their sign language command. In this way, the user can be put on notice of when the sign language command will be acted upon, and how much time they have to cancel or correct any input or interpretation of the input. When the user does not provide a corrective or other input before expiration of the timer, the automated assistant 204 can act on the sign language command.

In some implementations, before, during, or after the user provides the sign language command, a suggestion engine 224 can utilize data generated by the input processing engine 206, and/or utilize any other data, to render suggestions at an assistant interface 220. The suggestions can be autocomplete suggestions for an ongoing sign language command, thereby allowing the user to select a suggestion instead of having to expressly sign every part of an ongoing command. Alternatively, or additionally, the suggestion engine 224 can provide suggestions regarding other actions that can be performed by the automated assistant and/or corrective language that can replace any incorrect interpretation of an ongoing sign language command. In this way, the user can be put on notice of any additional features that the automated assistant 204 can perform in response to a sign language command, as well as be made aware of any interpretation of an ongoing sign language command in real-time.

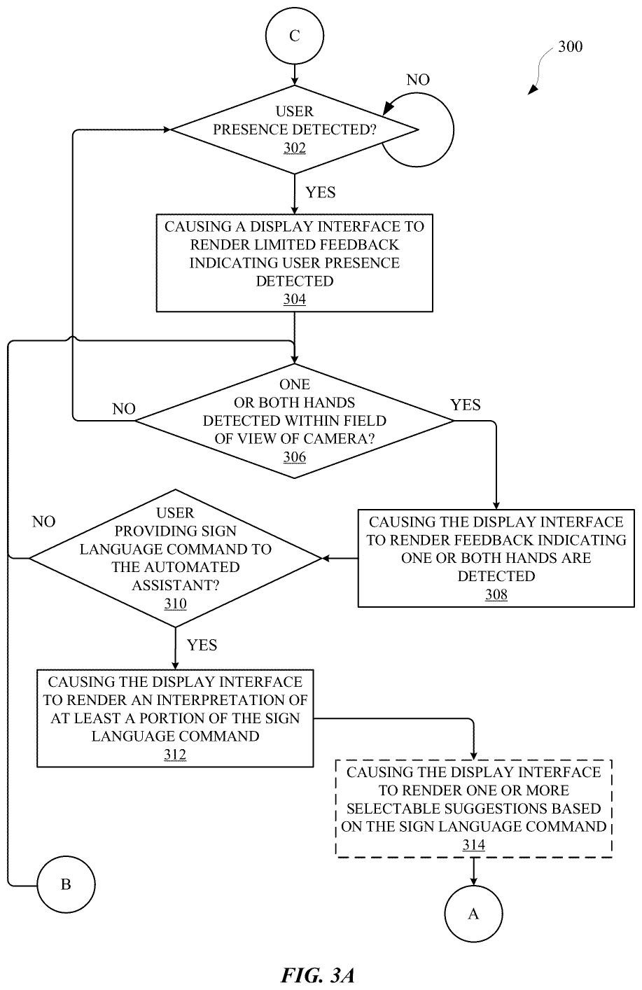

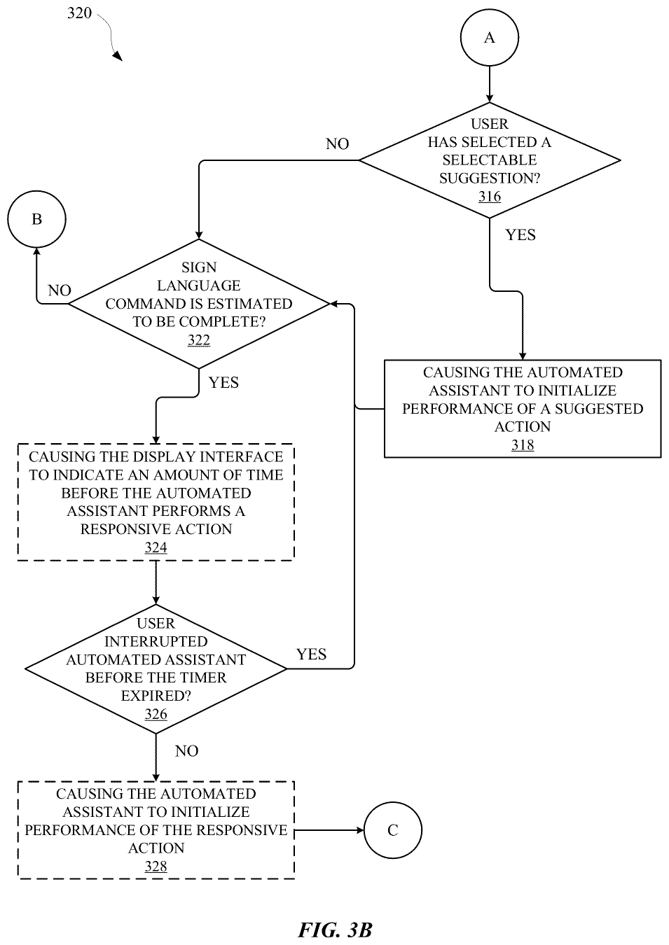

FIG. 3A illustrates a method 300 and FIG. 3B illustrates a method 320 for operating an automated assistant that facilitates interactions through sign language commands and/or inaudible gestures and provides discoverability of features for making such interactions more efficient. The method 300 and the method 320 can be performed by one or more applications, devices, and/or apparatus or module capable of interacting with an automated assistant. The method 300 can include an operation 302 of determining whether a presence of a user is being, or has been, detected. For example, the automated assistant can operate at a standalone display device with one or more sensors (e.g., a camera and/or other visual sensors) for receiving input data associated with the surroundings of the device. When input vision data indicates that motion of a human is being detected, and/or that a user is directing their gaze at the display device, the automated assistant can cause the display device to provide feedback. For example, the feedback can include an inaudible output, such as a change to an operation of a light and/or display panel of the display device (e.g., turning on the display and/or light, blinking the light, and/or otherwise transitioning out of a low power mode).

When presence of the user is detected at the operation 302, the method 300 can proceed from the operation 302 to an operation 304. The operation 304 can include causing a display interface of a computing device (e.g., the standalone display device) to render the feedback indicating that the presence of the user has been detected. Otherwise, the operation 302 can be performed until a presence of the user has been detected, with prior permission from the user. The method 300 can proceed from the operation 304 to an operation 306, which can include determining whether one or both hands of the user are detected within a field of view of a camera. The camera can be integral to the computing device and/or otherwise associated with the automated assistant and attached to a separate device. Determining that a hand of the user is within the field of view of the camera can include employing one or more heuristic processes and/or one or more trained machine learning models to detect the hand of the user. In some implementations, when a trained machine learning model is utilized, the trained machine learning model can facilitate user recognition based on labeled training captured with prior permission from the user. In some implementations, such recognition can be performed on-device without transmitting any input data to a server or other computing device, or, alternatively, can be offloaded to a server device for preserving resources of any local computing device.

When one or both hands of the user are detected within the field of view of the camera of the computing device, the method 300 can proceed from the operation 306 to an operation 308. Otherwise, the method 300 can return to the operation 302 until one or both hands of the user are detected within the field of view of the user, and/or the automated assistant otherwise determines to perform a separate action. The operation 308 can include causing the display interface of the computing device to render additional feedback indicating one or more hands of the user have been detected. In some implementations, this additional feedback can include further changes to operations of a light of the computing device and/or display interface of the computing device. For example, the feedback can include rendering a static or dynamic (e.g., in motion) outline of one or more both hands of the user, rendering an avatar that has hands arranged to mimic the hands of the user, and/or otherwise rendering one or more symbols or texts indicating that one or both hands of the user have been detected.

The method 300 can proceed from the operation 308 to an operation 310, which can include determining whether the user is providing a sign language command to the automated assistant. In some implementations, determining whether the user is providing a sign language command can include a variety of heuristic processes and/or employing one or more trained machine learning models. In some implementations, in determining a sign language command or portion thereof (if any), trained machine learning model(s) (e.g., neural network model(s)) that are stored locally on an assistant device are utilized by the client device to at least selectively process at least portions of sensor data from sensor component(s) of the client device (e.g., image frames from camera(s) of the client device, audio data from microphone(s) of the device, etc.). For example, in response to detecting presence of one or more users, the client device can process, for at least a duration (e.g., for at least a threshold duration and/or until presence is no longer detected) at least portion(s) of vision data utilizing locally stored machine learning model(s) in monitoring for occurrence of a directed gaze of a user, determining distance(s) of the user, determining co-occurrence of mouth movement and voice activity, determining and classifying hand movements and/or other non-verbal gestures, performing facial recognition, and/or determining occurrence of other attribute(s).

The client device can detect presence of one or more users using a dedicated presence sensor (e.g., a passive infrared sensor (PIR)), using vision data and a separate machine learning model (e.g., a separate machine learning model trained solely for human presence detection), and/or using audio data and a separate machine learning model (e.g., VAD using a VAD machine learning model or ambient audio detection model to detect, for example, footsteps). In implementations where processing of vision data and/or audio data in determining occurrence of a sign language command is contingent on first detecting presence of one or more users, power resources can be conserved through the non-continuous processing of vision data and/or audio data in monitoring for occurrence of attribute(s). Rather, in those implementations, the processing can occur only in response to detecting, via one or more lower-power consumption techniques, presence of one or more user(s) in an environment of the assistant device.

In some implementations where local machine learning model(s) are utilized in monitoring for occurrence directed gaze, brow movement, sign language commands, other facial movements, distance, facial recognition, and/or a gesture(s), different model(s) can be utilized, with each monitoring for occurrence of one or more different attribute(s). In some versions of those implementations, one or more “upstream” models (e.g., object detection and classification model(s)) can be utilized to detect portions of vision data (e.g., image(s)) that are likely a face, hands, fingers, eye(s), mouth, etc.—and those portion(s) processed using a respective machine learning model. For example, face and/or eye portion(s) of an image can be detected using the upstream model, and processed using a gaze machine learning model. Also, for example, finger and/or arm portion(s) of an image can be detected using the upstream model and processed using a finger movement (optionally co-occurring with arm movement) machine learning model. As yet another example, human portion(s) of an image can be detected using the upstream model and processed using a gesture machine learning model.

In some implementations, certain portions of video(s)/image(s) can be filtered out/ignored/weighted less heavily in detecting occurrence of one or more attributes. For example, a television captured in video(s)/image(s) can be ignored to prevent false detections as a result of a person rendered by the television (e.g., a weatherperson). For instance, a portion of an image can be determined to correspond to a television based on a separate object detection/classification machine learning model, in response to detecting a certain display frequency in that portion (i.e., that matches a television refresh rate) over multiple frames for that portion, etc. Such a portion can be ignored in certain techniques described herein, to prevent detection of those various attributes from a television or other video display device. As another example, picture frames can be ignored. These and other techniques can mitigate false-positive adaptations of an automated assistant, which can conserve various computational and/or network resources that would otherwise be consumed in a false-positive adaptations. Also, in various implementations, once a TV, picture frame, etc. location is detected, it can optionally continue to be ignored over multiple frames (e.g., while verifying intermittently, until movement of client device or object(s) is detected, etc.). This can also conserve various computational resources.

The method 300 can proceed from the operation 310 to an operation 312 when the user is determined to be providing a sign language command to the automated. Otherwise, the method 300 can proceed from the operation 310 to the operation 306. The operation 312 can include causing the display interface to render an interpretation of at least a portion of the sign language command. In some implementations, the interpretation of the sign language command can be rendered as natural language text (e.g., English words and alphabetic characters), American Sign Language (ASL) Gloss (e.g., natural language text with non-alphabetic symbols), depictions of hand language signs, and/or any other representation of an interpretation of a sign language command.

The method 300 can proceed from the operation 312 to an operation 314, which can be an optional operation that includes causing the display interface to render one or more selectable suggestions based on the sign language command. In some implementations, a selectable suggestion can be a graphical user interface (GUI) element that can be tapped via a touch input to a touch display interface and/or any other selectable feature of an application. Each selectable suggestion can include content that indicates an additional input and/or action that, when selected, can further any ongoing interaction with the automated assistant. For example, a first selectable suggestion that is rendered can include an auto-complete suggestion for the sign language command, and the content of the first selectable suggestion can be rendered as text, hand symbols, and/or ASL Gloss. In some implementations, the first selectable suggestion can include additional content that indicates a sign language command or other input that can be provided to select the first selectable suggestion. In some implementations, a second selectable suggestion that is rendered can correspond to an action that may be associated with the sign language command that the user is providing to the automated assistant. For example, the second selectable suggestion can correspond to an action that the user has not previously requested the automated assistant to perform, thereby allowing the user to discover helpful features of the automated assistant.

The method 300 can proceed, via continuation element “A”, from the operation 314 in FIG. 3A, to an operation 316 in FIG. 3B. The operation 316 can include determining whether the user has selected a selectable suggestion. When the user is determined to have selected a selectable suggestion, the method 300 can proceed from the operation 316 to an operation 318, which can include causing the automated assistant to initialize performance of a suggested action corresponding to the selected selectable suggestion. For example, the suggested action can include replacing or appending a word, phrase, letter, and/or symbol for an interpretation of the sign language command being provided by the user. This addition or replacement for the interpretation can then be processed with any initial interpretation of the sign language command in furtherance of performing a corrective action in response to the user providing the sign language command (e.g., responding to a corrected interpretation instead of any incorrect initial interpretation). The method 300 can proceed from the operation 318 to an operation 322. Otherwise, when the user does not select a selectable suggestion within a threshold duration of time and/or within the time that they are providing the sign language command, the method 320 can proceed from the operation 316 to the operation 322.

The operation 322 can include determining whether the sign language command is estimated to be completed. In some implementations, this estimation can be based on one or more heuristic processes and/or one or more trained machine learning models. For example, a gesture model can be trained based on prior interactions between the user and the automated assistant, and/or between other users and their respective automated assistant (with prior permission from any involved users). Furthermore, additional feedback to the automated assistant through other non-verbal gestures (e.g., moving eyebrows, blinking, mouth movements, etc.) can be processed, using the gesture model with any vision data characterizing the sign language command, to determine whether the user is intending for the sign language command to be considered completed. When the sign language command is estimated to be completed, the method 320 can proceed from the operation 322 to an optional operation 324. Otherwise, the method 320 can proceed, via continuation element “B”, from the operation 322 of FIG. 3B to operation 306 of FIG. 3A.

The optional operation 324 can include causing the display interface of the computing device (e.g., the standalone display device) to indicate an amount of time before the automated performs a responsive action or otherwise initiates performance of the responsive action. In some implementations, this amount of time can be indicated with a graphical or textual countdown timer, such as a dynamic status bar, stopwatch style countdown, and/or any other suitable GUI elements for indicating an amount of time before an action is going to be performed. In this way, the user can view an interpretation of their sign language command and decide whether to interrupt processing of the interpretation. This can reduce processing of unintended interpretations, thereby preserving resources at the computing device, and any affected server devices.

The method 320 can proceed from the operation 324 to an operation 326 for determining whether the user interrupted the automated assistant before the timer expired. When the user is determined to have interrupted the automated assistant during the amount of time for the timer, the method 320 can proceed from the operation 326 to the operation 322. Otherwise, the method 320 can proceed from the operation 326 to an operation 328. The operation 328 can include causing the automated assistant to initialize performance of the responsive action (i.e., one or more actions the automated assistant has determined to be responsive to the sign language command from the user). The method 320 can then proceed from the operation 328, via continuation element “C”, back to the operation 302 for further detection of any requests from the user.

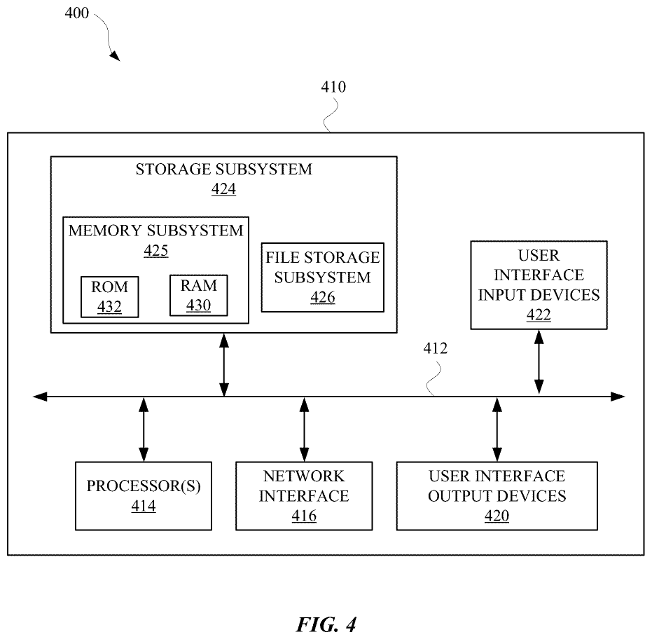

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, the method 320, and/or to implement one or more of system 200, computing device 104, automated assistant, and/or any other application, device, apparatus, and/or module discussed herein.

These software modules are generally executed by processor 414 alone or in combination with other processors. Memory 425 used in the storage subsystem 424 can include a number of memories including a main random-access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple buses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by one or more processors is provided, and includes determining, by an automated assistant application, that one or both hands of a user are located within a field of view of a camera of a computing device. The automated assistant application is responsive to sign language commands performed by one or both hands of the user. The method further includes causing a display interface of the computing device to render an output in response to determining that one or both hands of the user are located within the field of view of the camera of the computing device. The output of the display interface indicates to the user that the automated assistant application is available for receiving one or more sign language commands. The method further includes determining, by the automated assistant application, that the user is providing the one or more sign language commands. The one or more sign language commands direct the automated assistant application, and/or a separate application, to initialize one or more actions. Further, the one or more sign language commands do not include an audible input. The method further includes causing the display interface of the computing device to render an additional output in response to determining that the user is providing the one or more sign language commands. The additional output indicates an interpretation of one or more sign language commands as determined by the automated assistant application. The method further includes causing the automated assistant application, and/or the separate application, to initialize the one or more actions in response to the user providing the one or more sign language commands.

These and other implementations of technology disclosed herein can optionally include one or more of the following features.

In some implementations, the method may further include, prior to determining that the one or more hands of the user are located within the field of view of the camera of the computing device: determining that the user is detected within the field of view of the camera of the computing device, or is detected by an additional sensor of the computing device. Detection of the user by the camera or the additional sensor may cause the automated assistant application to initialize additional detection of one or more both hands of the user.

In some versions of those implementations, determining that the user is detected within the field of view of the camera of the user may include determining that a face or a gaze of the user is directed towards the camera of the computing device.

In additional or alternative versions of those implementations, determining that the user is detected within the field of view of the camera of the user may include determining that a gaze of the user is directed towards one or more graphical elements that are static, or in motion, at the display interface of the computing device.

In additional or alternative versions of those implementations, determining that the user is within the field of view of the camera of the computing device, or is detected by the additional sensor of the computing device, may be performed when the computing device is operating in a low power mode, relative to default or another power mode that the computing device is operating in when the user is providing the one or more sign language commands.

In some further versions of those implementations, the camera of the computing device may operate according to a reduced sampling rate when the computing device is operating in the low power mode, or the camera may be off and the additional sensor is operational when the computing device is operating in the low power mode.

In some implementations, causing the display interface of the computing device to render the additional output may include: causing the additional output to include an animation that mimics movement of the one or both hands of the user simultaneous to the user providing the one or more sign language commands.

In some implementations, causing the display interface of the computing device to render the output may include: causing the output to include a static, or dynamic, outline of one or both hands of the user to be rendered at the display interface, or to include an avatar that is mimicking an arrangement or a movement of one or more hands of the user.

In some implementations, the method may further include determining, prior to causing the automated assistant application and/or the separate application to initialize the one or more actions, that the user has completed providing the one or more sign language commands; and causing, in response to determining that the user has completed providing the one or more sign language commands, the display interface of the computing device to render a graphical timer that indicates an amount of time before the automated assistant initializes the one or more actions. During the amount of time before the automated assistant application initializes the one or more actions, the automated assistant application may receive a particular sign language command or other gesture for preventing initialization of the one or more actions. Further, the one or more actions may be initialized when the user does not provide the particular sign language command during the amount of time.

In some versions of those implementations, determining that the user has completed providing the one or more sign language commands may include determining that one or both hands of the user are no longer within the field of view of the camera of the computing device.

In some further versions of those implementations, the other gesture may include the user relocating one or both hands of the user to be within the field of view of the camera of the computing device.

In additional or alternative versions of those implementations, the method may further include causing, in response to determining that the user has completed providing the one or more sign language commands, the display interface of the computing device to render selectable elements. A particular selectable element of the selectable elements may be selected in response to the user providing the particular sign language command, and the one or more actions may be initialized when the user selects a separate selectable element of the selectable elements during the amount of time for the graphical timer.

In some implementations, causing the display interface of the computing device to render the additional output may include causing the display interface to provide an American Sign Language (ASL) Gloss interpretation of the one or more sign language commands.

In some implementations, causing the display interface of the computing device to render the additional output may include causing the display interface to provide a natural language interpretation of an American Sign Language (ASL) Gloss interpretation of the one or more sign language commands.

In some versions of those implementations, the method may further include generating, using a generative model, the natural language interpretation of the ASL gloss interpretation.

In some further versions of those implementations, the generative model may be fine-tuned to generate the natural language interpretation of the ASL gloss interpretation, and fine-tuning the generative model to generate the natural language interpretation of the ASL gloss interpretation may include: obtaining a plurality of training instances, each of the plurality of training instances including training instance input and training instance output, the training instance input including a corresponding training ASL gloss interpretation, and the training instance output including a corresponding natural language interpretation of the corresponding ASL gloss interpretation; and fine-tuning, based on the plurality of training instances, the generative model.

In some implementations, a method implemented by one or more processors is provided, and includes determining, by an automated assistant application, that a user has provided an initial portion of a sign language command to a computing device. The sign language command is detected using a camera or other vision sensor of the computing device, and the sign language command does not include an audible input. The method further includes determining, based on the initial portion of the sign language command, a suggested portion for the sign language command; causing a display interface of the computing device to render selectable content that identifies the suggested portion for the sign language command; and determining that the user has provided an additional command for selecting the suggested portion for completing the sign language command. The additional command may cause the automated assistant application to process the suggested portion with the initial portion of the sign language command provided by the user. The method further includes causing the automated assistant application to initialize performance of an action that is based on the sign language command that includes at least the initial portion of the sign language command and the suggested portion of the sign language command.

These and other implementations of technology disclosed herein can optionally include one or more of the following features.

In some implementations, the suggested portion may be further based on one or more prior interactions between the user and the automated assistant application.

In some implementations, the suggested portion may be further based on one or more prior interactions between other users and respective instances of the automated assistant application.

In some implementations, the method may further include causing the display interface of the computing device to render graphical content that identifies an American Sign Language (ASL) Gloss interpretation of the initial portion of the sign language command.

In some versions of those implementations, the ASL Gloss interpretation may include an alphabetic character and a non-alphabetic character.

In some further versions of those implementations, the selectable content that identifies the suggested portion for the sign language command may include a separate ASL Gloss interpretation of the suggested portion of the sign language command.

In some implementations, the method may further include causing the display interface of the computing device to render graphical content that identifies a natural language interpretation of an American Sign Language (ASL) Gloss interpretation of the one or more sign language commands.

In some versions of those implementations, the method may further include generating, using a generative model, the natural language interpretation of the ASL gloss interpretation.

In some further versions of those implementations, the generative model may be fine-tuned to generate the natural language interpretation of the ASL gloss interpretation, and fine-tuning the generative model to generate the natural language interpretation of the ASL gloss interpretation may include: obtaining a plurality of training instances, each of the plurality of training instances including training instance input and training instance output, the training instance input including a corresponding training ASL gloss interpretation, and the training instance output including a corresponding natural language interpretation of the corresponding ASL gloss interpretation; and fine-tuning, based on the plurality of training instances, the generative model.

In additional or alternative further versions of those implementations, the natural language interpretation the ASL Gloss interpretation includes alphabetic characters.

In additional or alternative further versions of those implementations, the selectable content that identifies the suggested portion for the sign language command may include a separate natural language interpretation of a separate ASL Gloss interpretation of the suggested portion of the sign language command.

In some implementations, a method implemented by one or more processors is provided, and includes determining, by an automated assistant application, that a user has provided an initial portion of a sign language command to a computing device. The sign language command is detected using a camera or other vision sensor of the computing device, and the sign language command does not include an audible input. The method further includes generating, based on the initial portion of the sign language command, graphical content data that characterizes an interpretation of the initial portion of the sign language command. The graphical content data identifies one or more symbols and/or natural language text. The method may further include causing, in response to the user providing the initial portion of the sign language command, graphical content to be rendered at the display interface using the graphical content data. The graphical content is rendered in furtherance of conveying the interpretation of the initial portion of the sign language command to the user. The method may further include determining whether the user provided a corrective input or a confirming input directed to the graphical content rendered at the display interface. The corrective input is provided to modify the interpretation of the initial portion of the sign language command, and the confirming input is provided to cause the automated assistant to further process the initial portion of the sign language command. The method may further include, when the automated assistant determines that the user has provided the corrective input to the automated assistant: causing the automated assistant to initiate performance of an action that corresponds to a corrected interpretation of the initial portion of the sign language command; and when the automated assistant determines that the user has provided the confirming input to the automated assistant: causing the automated assistant to initiate performance of a separate action that corresponds to the interpretation of the initial portion of the sign language command.

These and other implementations of technology disclosed herein can optionally include one or more of the following features.

In some implementations, the method may further include, causing, in response to the user providing the initial portion of the sign language command, additional graphical content to be rendered at the display interface for indicating a selectable suggestion. The selectable suggestion may indicate a particular action that the user has not expressly requested the automated assistant to perform, and that is associated with action or the separate action.

In some versions of those implementations, the additional graphical content may include a graphical depiction of a sign language command that can be performed by the user to select the selectable suggestion.

Other implementations may include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

We claim:

1. A method implemented by one or more processors, the method comprising:
determining, by an automated assistant application, that one or both hands of a user are located within a field of view of a camera of a computing device,
wherein the automated assistant application is responsive to sign language commands performed by one or both hands of the user;
causing a display interface of the computing device to render an output in response to determining that one or both hands of the user are located within the field of view of the camera of the computing device,
wherein the output of the display interface indicates to the user that the automated assistant application is available for receiving one or more sign language commands;
determining, by the automated assistant application, that the user is providing the one or more sign language commands,
wherein the one or more sign language commands direct the automated assistant application, and/or a separate application, to initialize one or more actions, and
wherein the one or more sign language commands do not include an audible input;
causing the display interface of the computing device to render an additional output in response to determining that the user is providing the one or more sign language commands,
wherein the additional output indicates an interpretation of one or more sign language commands as determined by the automated assistant application; and
causing the automated assistant application, and/or the separate application, to initialize the one or more actions in response to the user providing the one or more sign language commands.

2. The method of claim 1, further comprising:
prior to determining that the one or more hands of the user are located within the field of view of the camera of the computing device:
determining that the user is detected within the field of view of the camera of the computing device, or is detected by an additional sensor of the computing device,
wherein detection of the user by the camera or the additional sensor causes the automated assistant application to initialize additional detection of one or more both hands of the user.

3. The method of claim 2, wherein determining that the user is detected within the field of view of the camera of the user includes determining that a face or a gaze of the user is directed towards the camera of the computing device.

4. The method of claim 2, wherein determining that the user is detected within the field of view of the camera of the user includes determining that a gaze of the user is directed towards one or more graphical elements that are static, or in motion, at the display interface of the computing device.

5. The method of claim 2, wherein determining that the user is within the field of view of the camera of the computing device, or is detected by the additional sensor of the computing device, is performed when the computing device is operating in a low power mode, relative to default or another power mode that the computing device is operating in when the user is providing the one or more sign language commands.

6. The method of claim 5,
wherein the camera of the computing device operates according to a reduced sampling rate when the computing device is operating in the low power mode, or
wherein the camera is off and the additional sensor is operational when the computing device is operating in the low power mode.

7. The method of claim 1, wherein causing the display interface of the computing device to render the additional output includes:
causing the additional output to include an animation that mimics movement of the one or both hands of the user simultaneous to the user providing the one or more sign language commands.

8. The method of claim 1, wherein causing the display interface of the computing device to render the output includes:
causing the output to include a static, or dynamic, outline of one or both hands of the user to be rendered at the display interface, or to include an avatar that is mimicking an arrangement or a movement of one or more hands of the user.

9. The method of claim 1, further comprising:
determining, prior to causing the automated assistant application and/or the separate application to initialize the one or more actions, that the user has completed providing the one or more sign language commands; and
causing, in response to determining that the user has completed providing the one or more sign language commands, the display interface of the computing device to render a graphical timer that indicates an amount of time before the automated assistant initializes the one or more actions,
wherein, during the amount of time before the automated assistant application initializes the one or more actions, the automated assistant application can receive a particular sign language command or other gesture for preventing initialization of the one or more actions, and
wherein the one or more actions are initialized when the user does not provide the particular sign language command during the amount of time.

10. The method of claim 9, wherein determining that the user has completed providing the one or more sign language commands includes determining that one or both hands of the user are no longer within the field of view of the camera of the computing device.

11. The method of claim 10, wherein the other gesture includes the user relocating one or both hands of the user to be within the field of view of the camera of the computing device.

12. The method of claim 9, further comprising:
causing, in response to determining that the user has completed providing the one or more sign language commands, the display interface of the computing device to render selectable elements,
wherein a particular selectable element of the selectable elements is selected in response to the user providing the particular sign language command, and
wherein the one or more actions are initialized when the user selects a separate selectable element of the selectable elements during the amount of time for the graphical timer.

13. The method of claim 1, wherein causing the display interface of the computing device to render the additional output comprises causing the display interface to provide an American Sign Language (ASL) Gloss interpretation of the one or more sign language commands.

14. The method of claim 1, wherein causing the display interface of the computing device to render the additional output comprises causing the display interface to provide a natural language interpretation of an American Sign Language (ASL) Gloss interpretation of the one or more sign language commands.

15. The method of claim 14, further comprising:
generating, using a generative model, the natural language interpretation of the ASL gloss interpretation.

16. The method of claim 15, wherein the generative model is fine-tuned to generate the natural language interpretation of the ASL gloss interpretation, and wherein fine-tuning the generative model to generate the natural language interpretation of the ASL gloss interpretation comprises:
obtaining a plurality of training instances, each of the plurality of training instances including training instance input and training instance output, the training instance input including a corresponding training ASL gloss interpretation, and the training instance output including a corresponding natural language interpretation of the corresponding ASL gloss interpretation; and
fine-tuning, based on the plurality of training instances, the generative model.

17. A system comprising:
one or more processors; and
memory storing instructions that, when executed, cause the one or more processors to be operable to:
determine, by an automated assistant application, that one or both hands of a user are located within a field of view of a camera of a computing device,
wherein the automated assistant application is responsive to sign language commands performed by one or both hands of the user;
cause a display interface of the computing device to render an output in response to determining that one or both hands of the user are located within the field of view of the camera of the computing device,
wherein the output of the display interface indicates to the user that the automated assistant application is available for receiving one or more sign language commands;
determine, by the automated assistant application, that the user is providing the one or more sign language commands,
wherein the one or more sign language commands direct the automated assistant application, and/or a separate application, to initialize one or more actions, and
wherein the one or more sign language commands do not include an audible input;
cause the display interface of the computing device to render an additional output in response to determining that the user is providing the one or more sign language commands,
wherein the additional output indicates an interpretation of one or more sign language commands as determined by the automated assistant application; and
cause the automated assistant application, and/or the separate application, to initialize the one or more actions in response to the user providing the one or more sign language commands.

18. A non-transitory computer-readable storage medium storing instructions that, when executed, cause one or more processors to perform operations, the operations comprising:
determining, by an automated assistant application, that one or both hands of a user are located within a field of view of a camera of a computing device,
wherein the automated assistant application is responsive to sign language commands performed by one or both hands of the user;
causing a display interface of the computing device to render an output in response to determining that one or both hands of the user are located within the field of view of the camera of the computing device,
wherein the output of the display interface indicates to the user that the automated assistant application is available for receiving one or more sign language commands;
determining, by the automated assistant application, that the user is providing the one or more sign language commands,
wherein the one or more sign language commands direct the automated assistant application, and/or a separate application, to initialize one or more actions, and
wherein the one or more sign language commands do not include an audible input;
causing the display interface of the computing device to render an additional output in response to determining that the user is providing the one or more sign language commands,
wherein the additional output indicates an interpretation of one or more sign language commands as determined by the automated assistant application; and
causing the automated assistant application, and/or the separate application, to initialize the one or more actions in response to the user providing the one or more sign language commands.
